(19) United States
(12) Patent Application Publication
(10) Pub. No.: US 2025/0276626 A1
(43) Pub. Date: Sep. 4, 2025

(54) VEHICLE SEAT

(71) Applicants: NHK SPRING CO., LTD., Yokohama-shi (JP); SUBARU CORPORATION, Tokyo (JP)

(72) Inventors: Jun TAKEDA, Yokohama-shi (JP); Mitsuaki ODA, Yokohama-shi (JP); Masato FUKUSHIMA, Tokyo (JP)

(21) Appl. No.: 19/058,783

(22) Filed: Feb. 20, 2025

(30) Foreign Application Priority Data
Feb. 29, 2024 (JP) 2024-030578

(51) Int. Cl. B60N 2/66; B60N 2/42; B60N 2/427

(52) U.S. Cl. CPC B60N 2/66; B60N 2/4221; B60N 2/42709; B60N 2/42781

(57) ABSTRACT

A vehicle seat includes a seatback that supports a back of a seated occupant from a seat rear side, a back frame that configures a framework of the seatback and that includes an insertion portion, and a lumbar support that is arranged at a position facing a lumbar region of the seated occupant in a seat front-rear direction within the seatback. The vehicle seat includes a wire that extends from the lumbar support toward an insertion portion side and that is anchored at the insertion portion in a state of being inserted into the insertion portion. A notch that is directly or indirectly anchored at an edge of the insertion portion when the lumbar support is pressed toward the seat rear side is formed at the wire.

### CROSS-REFERENCE TO RELATED APPLICATION

This application is based on and claims priority under 35 USC 119 from Japanese Patent Application No. 2024-030578 filed on Feb. 29, 2024, the disclosure of which is incorporated by reference herein.

### BACKGROUND

### Technical Field

The present disclosure relates to a vehicle seat.

### Related Art

Japanese Patent Application Laid-Open (JP-A) No. 2011-136649 discloses a vehicle seat including a lumbar support (posture holding member) that supports a lumbar region of a seated occupant. Wires extending toward a back frame side are anchored at the lumbar support described in this document. Further, the lumbar support is supported by the back frame via the wires, due to the wires being inserted into holes (axial support portions) formed at the back frame.

During a rear-end collision of the vehicle, the lumbar support is pressed with strong force toward a seat rear side. Therefore, it is important to prevent the wires supporting the lumbar support from coming loose from the back frame, but the configuration described in Japanese Patent Application Laid-Open (JP-A) No. 2011-136649 has room for improvement in this respect.

### SUMMARY

The present disclosure obtains a vehicle seat that is capable of preventing a wire supporting a lumbar support from coming loose from a back frame.

A vehicle seat of a first aspect includes: a seatback that supports a back of a seated occupant from a seat rear side; a back frame that configures a framework of the seatback and that includes an insertion portion; a lumbar support that is arranged at a position facing a lumbar region of the seated occupant in a seat front-rear direction within the seatback; and a wire that extends from the lumbar support toward an insertion portion side and that is anchored at the insertion portion in a state of being inserted into the insertion portion, a notch that is directly or indirectly anchored at an edge of the insertion portion when the lumbar support is pressed toward the seat rear side being formed at the wire.

In the vehicle seat of the first aspect, the back of the seated occupant is supported from the seat rear side by the seatback, and the lumbar region of the seated occupant is supported from the seat rear side by the lumbar support. The wire extends from the lumbar support, and is anchored at the insertion portion of the back frame in a state in which the wire is inserted into the insertion portion. Consequently, the lumbar support is supported by the back frame via the wire. When the lumbar support is pressed toward the seat rear side during a rear-end collision of the vehicle, the notch formed at the wire is directly or indirectly anchored at the edge of the insertion portion. Consequently, the wire that supports the lumbar support can be prevented from coming loose from the back frame.

A vehicle seat of a second aspect is the vehicle seat of the first aspect, wherein a bushing is attached to the edge of the insertion portion, and, when a force with which the lumbar support is pressed toward the seat rear side exceeds a predetermined load, the bushing is broken, and the notch is directly anchored at the edge of the insertion portion.

In the vehicle seat of the second aspect, the bushing is attached to the edge of the insertion portion. When a force with which the lumbar support is pressed toward the seat rear side exceeds the predetermined load, the bushing is broken, and the notch is directly anchored at the edge of the insertion portion. Due to the notch being configured to be directly anchored at the edge of the insertion portion in this manner, the wire that supports the lumbar support can be more robustly prevented from coming loose from the back frame.

A vehicle seat of a third aspect is the vehicle seat of the first aspect, wherein a bushing that includes a portion formed in a shape that gradually narrows on progression toward a direction in which the wire is inserted into the insertion portion is attached to the edge of the insertion portion.

In the vehicle seat of the third aspect, the bushing is attached to the edge of the insertion portion. The bushing includes the portion formed in a shape that gradually narrows on progression toward the direction in which the wire is inserted into the insertion portion. Therefore, when the wire is inserted into the insertion portion, a leading end of the wire can be guided toward the insertion portion side along the aforementioned portion of the bushing. Consequently, workability when inserting the wire into the insertion portion can be improved.

The vehicle seat according to the present disclosure has an effect in that it is capable of preventing a wire supporting a lumbar support from coming loose from a back frame.

### BRIEF DESCRIPTION OF THE DRAWINGS

An exemplary embodiment of the present disclosure will be described in detail based on the following figures, wherein:

FIG. 1 is a side view schematically illustrating a vehicle seat according to the present exemplary embodiments;

FIG. 2 is a front view illustrating a lumbar unit that is supported by a back frame;

FIG. 3 is an enlarged perspective view illustrating a vicinity of an upper side anchoring portion of a support wire in an enlarged manner;

FIG. 4 is a cross-sectional view illustrating the support wire, an intermediate frame portion, and a bushing at a portion corresponding to the upper side anchoring portion of the support wire in a cross-section taken along a front-rear direction and an up-down direction;

FIG. 5 is a cross-sectional view corresponding to FIG. 4 and illustrates a state at a time when a vehicle has undergone a rear-end collision.

### DETAILED DESCRIPTION

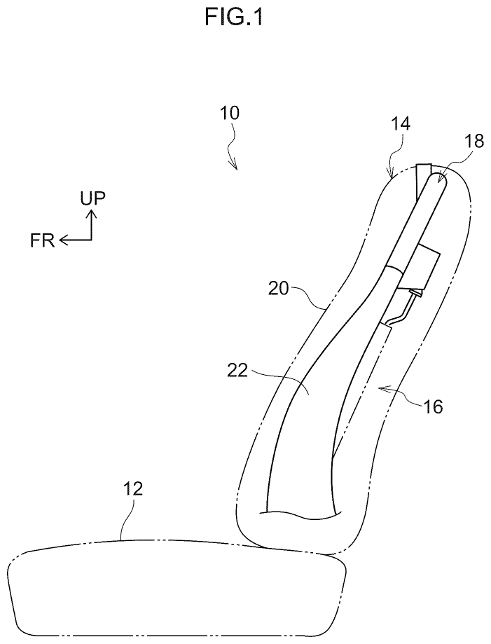

A vehicle seat 10 according to an exemplary embodiment of the present disclosure will be explained, with reference to FIGS. 1 to 5. It should be noted that, in the drawings, arrow FR indicates a seat front side, arrow UP indicates a seat upper side, arrow LH indicates a seat width direction left side, and arrow RH indicates a seat width direction right side, respectively. Further, unless specifically stated otherwise, in the following explanation, reference to front-rear, up-down, and left-right directions refers to front and rear in a seat front-rear direction, up and down in a seat up-down direction, and left and right in a seat width direction.

As illustrated in FIG. 1, the vehicle seat 10 of the present exemplary embodiment includes a seat cushion 12 that supports buttocks of a seated occupant from a lower side, a seatback 14 that supports a back of the seated occupant from a rear side, and a lumbar support unit 16 that is provided within the seatback 14.

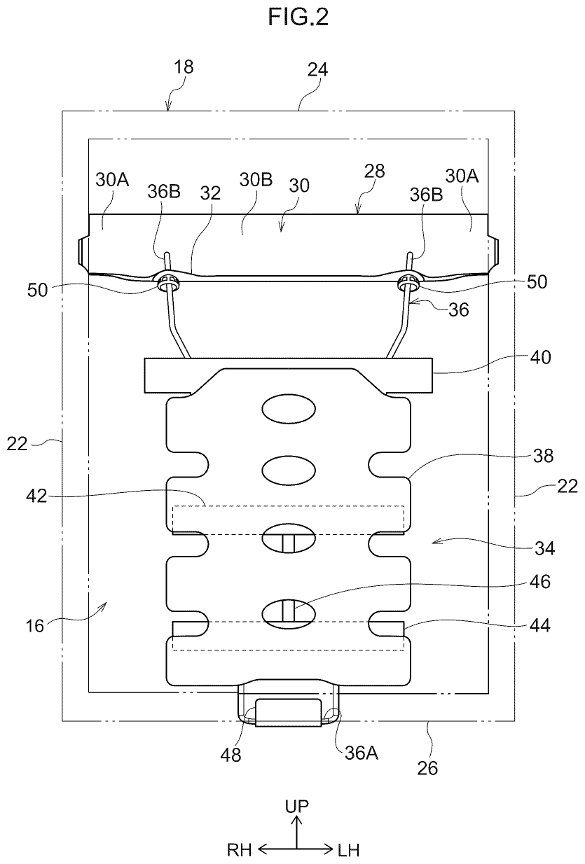

As illustrated in FIGS. 1 and 2, the seatback 14 is configured to include a back frame 18 that configures a framework of the seatback 14, and a back pad 20 that is attached to the back frame 18.

The back frame 18 is provided with a left and right pair of side frame portions 22 that are arranged at an interval in the seat width direction and that extend in the up-down direction. Further, the back frame 18 includes an upper frame portion 24 that connects upper end portions of the left and right pair of side frame portions 22 in the seat width direction, and a lower frame portion 26 that connects lower end portions of the left and right pair of side frame portions 22 in the seat width direction. Moreover, the back frame 18 includes an intermediate frame portion 28 that connects upper side portions of the left and right pair of side frame portions 22 in the seat width direction at a lower side of the upper frame portion 24.

The intermediate frame portion 28 is formed, for example, by performing press working or the like on a steel plate material. The intermediate frame portion 28 includes a base plate portion 30 that extends in the left-right direction. Both left-right direction end portions 30A of the base plate portion 30 are offset toward a front side with respect to a left-right direction intermediate portion 30B of the base plate portion 30. Both of the left-right direction end portions 30A of the base plate portion 30 are joined to the left and right pair of side frame portions 22 by welding or the like. Further, the intermediate frame portion 28 is provided with a lower flange portion 32 that extends toward the front side from a lower end of the left-right direction intermediate portion 30B.

As illustrated in FIG. 2, the lumbar support unit 16 is configured to include a lumbar support 34 that is arranged at a position facing a lumbar region of the seated occupant in the front-rear direction within the seatback 14, and a support wire 36 serving as a wire for allowing the back frame 18 to support the lumbar support 34.

The lumbar support 34 includes a lumbar plate 38 that is formed using, for example, a resin material. The lumbar plate 38 is formed in a rectangular shape in a seat front view, is formed in a plate shape with a thickness direction thereof being along the front-rear direction, and has a configuration in which weight-reduction punching is appropriately performed at both left and right end portions and a center portion. Further, the lumbar support 34 includes a first fixing member 40, a second fixing member 42, and a third fixing member 44 that extend in the left-right direction at a rear side of the lumbar plate 38 and that are arranged at intervals in the up-down direction. The first fixing member 40 is fixed to an upper end portion of the lumbar plate 38. Furthermore, the second fixing member 42 is fixed to a center portion in the up-down direction of the lumbar plate 38. Moreover, the third fixing member 44 is fixed to a lower end portion of the lumbar plate 38. Further, the lumbar support 34 is provided with an actuator portion 46 that is provided at the rear side of the lumbar plate 38. The actuator portion 46 is supported in a state in which it is spanned between the second fixing member 42 and the third fixing member 44. Due to actuation of the actuator portion 46, the interval in the up-down direction between the second fixing member 42 and the third fixing member 44 is changed, and the shape of the lumbar plate 38 is changed.

The support wire 36 is formed, for example, by performing bending work or the like on a rod-shaped steel material, and is bent into substantially a U-shape and a shape having left-right symmetry, with an upper side thereof being open in a seat front view. Respective portions of the support wire 36 are respectively anchored to the first fixing member 40, the second fixing member 42, and the third fixing member 44. A length direction center portion 36A of the support wire 36 is arranged at a lower side of the lumber plate 38 in a seat front view. Further, the length direction center portion 36A of the support wire 36 is fixed to the lower frame portion 26 via a bracket 48. Furthermore, an end portion 36B at one side of the support wire 36 extends toward an upper side with respect to an end portion at a left side of the first fixing member 40. Moreover, an end portion 36B at the other side of the support wire 36 extends toward the upper side with respect to an end portion at a right side of the first fixing member 40.

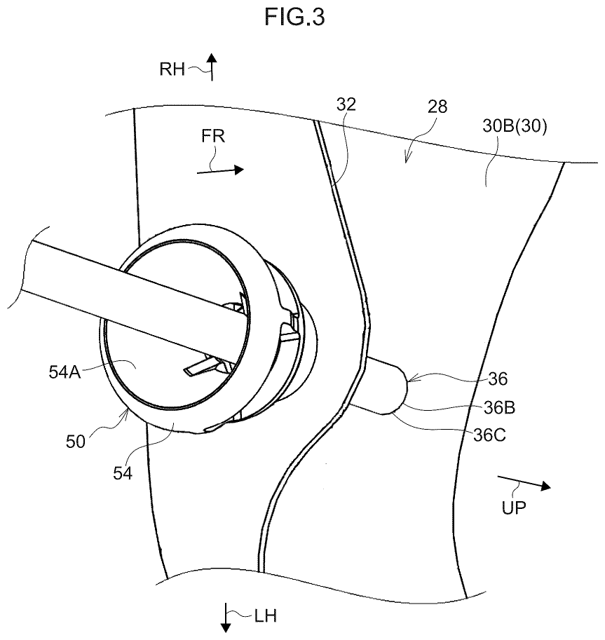

As illustrated in FIGS. 2 and 3, the end portion 36B at the one side of the support wire 36 and the end portion 36B at the other side of the support wire 36 are respectively anchored to both seat width direction end portions of the lower flange portion 32 of the intermediate frame portion 28. It should be noted that a configuration of an anchoring portion between the end portion 36B at the one side of the support wire 36 and the end portion at the left side of the lower flange portion 32, and a configuration of an anchoring portion between the end portion 36B at the other side of the support wire 36 and the end portion at the right side of the lower flange portion 32, are configurations that are the same as each other. Thus, in the following explanation, the configuration of the anchoring portion between the end portion 36B at the one side of the support wire 36 and the end portion at the left side of the lower flange portion 32 will be explained, and explanation regarding the configuration of the anchoring portion between the end portion 36B at the other side of the support wire 36 and the end portion at the right side of the lower flange portion 32 will be omitted.

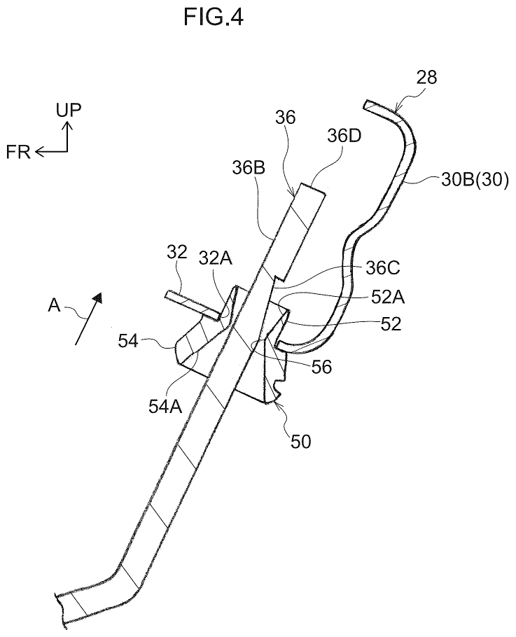

As illustrated in FIGS. 3 and 4, the lower flange portion 32 is inclined toward the lower side on progression toward the rear side. An insertion hole 32A, serving as an insertion portion into which the end portion 36B at the one side of the support wire 36 is inserted from the lower side, is formed at the end portion at the left side of the lower flange portion 32 so as to penetrate the lower flange portion 32. A shape of an edge of the insertion hole 32A as viewed from a thickness direction of the lower flange portion 32 is a circular shape. It should be noted that, in the following explanation, an insertion direction of the end portion 36B at the one end of the support wire 36 into the insertion hole 32A is simply referred to as an insertion direction A (arrow A direction) in some cases.

A bushing 50 is attached to a circumference of the insertion hole 32A in the lower flange portion 32. The bushing 50 is formed in a tube shape using, for example, a resin material. The bushing 50 includes a first tube-shaped portion 52 that is formed in a tube shape, and a second tube-shaped portion 54 that is formed in a tube shape and connected to the first tube-shaped portion 52 at a lower side of the first tube-shaped portion 52. The first tube-shaped portion 52 and the second tube-shaped portion 54 are coaxially arranged. An outer diameter of the first tube-shaped portion 52 is set to be smaller than an outer diameter of the second tube-shaped portion 54. Further, an inner face of the first tube-shaped portion 52 has a first tapered face 52A that gradually narrows on progression toward the second tube-shaped portion 54 side. Furthermore, an inner face of the second tube-shaped portion 54 has a second tapered face 54A that gradually narrows on progression toward the first tube-shaped portion 52 side. A connecting portion between the first tapered face 52A and the second tapered face 54A at an inner peripheral portion of the bushing 50 is configured as a corner portion 56 having a shape that is pointed toward a radial direction inner side of the bushing 50. The bushing 50 explained above is attached to the lower flange portion 32 due to the first tube-shaped portion 52 being inserted into the insertion hole 32A formed at the lower flange portion 32 from the lower side. It should be noted that attachment of the bushing 50 to the lower flange portion 32 is completed in a state in which the second tube-shaped portion 54 is in contact with a lower face of the lower flange portion 32. In a state in which attachment of the bushing 50 to the lower flange portion 32 has been completed, the corner portion 56 of the bushing 50 is arranged at a radial direction inner side of the edge of the insertion hole 32A.

As illustrated in FIG. 4, a notch 36C having a shape that is concave toward a center portion side of the support wire 36 is formed at a rear portion of the end portion 36B at the one side of the support wire 36. An amount of concavity of the notch 36C with respect to an outer peripheral face of the support wire 36 becomes gradually deeper on progression toward the insertion direction A side. The end portion 36B at the one side of the support wire 36 explained above is inserted from the lower side into the insertion hole 32A formed at the end portion at the left side of the lower flange portion 32 and into the bushing 50 attached to the lower flange portion 32. Consequently, anchoring of the end portion 36B at the one side of the support wire 36 to the lower flange portion 32 is completed. In a state in which anchoring of the end portion 36B at the one side of the support wire 36 to the lower flange portion 32 has been completed, a lower end portion of the notch 36C formed at the rear portion of the end portion 36B at the one side of the support wire 36 is arranged proximate to the corner portion 56 of the bushing 50 in the front-rear direction.

### Operation and Advantageous Effects of Present Exemplary Embodiment

Next, operation and advantageous effects of the present exemplary embodiment will be explained.

As illustrated in FIGS. 1 and 2, in the vehicle seat 10 of the present exemplary embodiment, the buttocks of the seated occupant are supported from the lower side by the seat cushion 12, and the back of the seated occupant is supported from the rear side by the seatback 14. Further, the lumbar region of the seated occupant is supported from the rear side by the lumbar support 34 via the back pad 20. When the actuator portion 46 of the lumbar support 34 is actuated, the interval in the up-down direction between the second fixing member 42 and the third fixing member 44 is changed, and the shape of the lumbar plate 38 is changed. Consequently, a state of support of the lumbar region by the lumbar plate 38 can be adjusted according to a body type or preference of the seated occupant.

It should be noted that the lumbar support 34 is supported by the back frame 18 via the support wire 36. As illustrated in FIGS. 3 and 4, the end portion 36B at the one end of the support wire 36 is inserted from the lower side into the insertion hole 32A that is formed at the end portion at the left side of the lower flange portion 32 and into the bushing 50 that is attached to the end portion at the left side of the lower flange portion 32. Although not illustrated in the drawings, the end portion 36B at the other side of the support wire 36 is inserted from the lower side into the insertion hole 32A that is formed at the end portion at the right side of the lower flange portion 32 and into the bushing 50 that is attached to the end portion at the right side of the lower flange portion 32.

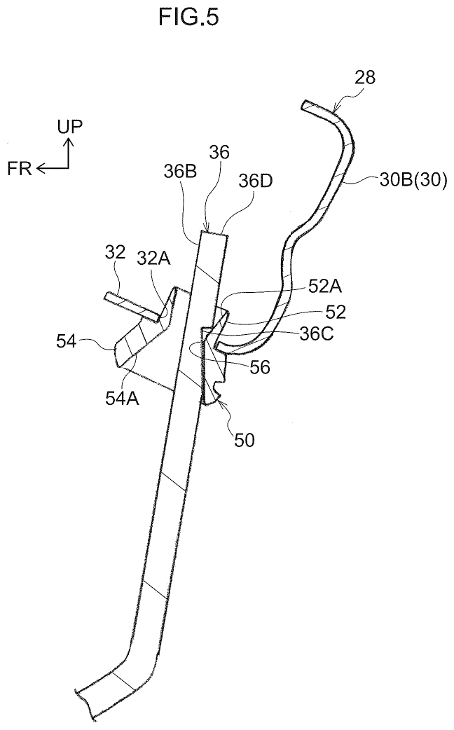

When the lumbar support 34 is pressed toward the rear side during a rear-end collision of the vehicle, the notch 36C that is formed at the support wire 36 is anchored at the corner portion 56 of the bushing 50 as illustrated in FIG. 5. That is to say, the notch 36C formed at the support wire 36 is indirectly anchored at the edge of the insertion hole 32A via the bushing 50. Consequently, the support wire 36 supporting the lumbar support 34 can be prevented from coming loose from the back frame 18 (the insertion hole 32A). Further, due to this configuration, it is unnecessary to increase an insertion amount of the support wire 36 into the insertion hole 32A in order to prevent the support wire 36 from coming loose from the insertion hole 32A. As a result, a protrusion amount of the support wire 36 toward the upper side with respect to the lower flange portion 32 can be reduced. As a result, a volume (capacity) occupied by the support wire 36 in a space within the seatback 14 can be reduced.

Further, in the present exemplary embodiment, when a force with which the lumbar support 34 is pressed toward the rear side exceeds a predetermined threshold value during a rear-end collision of the vehicle, the bushing 50 is broken (destroyed), and the notch 36C that is formed at the support wire 36 is directly anchored at the edge of the insertion hole 32A. Due to the notch 36C being configured to be directly anchored at the edge of the insertion hole 32A in this manner, the support wire 36 that supports the lumbar support 34 can be more robustly prevented from coming loose from the back frame 18 (the insertion hole 32A).

Furthermore, in the present exemplary embodiment, as illustrated in FIGS. 3 and 4, the inner face of the second tube-shaped portion 54 of the bushing 50 has the second tapered face 54A that gradually narrows on progression toward the first tube-shaped portion 52 side (the insertion direction A side). Due to this configuration, when the support wire 36 is inserted into the insertion hole 32A, a leading end 36D of the support wire 36 can be guided toward the insertion hole 32A side along the second tapered face 54A. Consequently, workability when inserting the support wire 36 into the insertion hole 32A can be improved.

It should be noted that, although an example in which the second tapered face 54A that functions as described above is provided at the bushing 50 has been explained in the present exemplary embodiment, the present disclosure is not limited thereto. Whether or not the second tapered face 54A that functions as described above is to be provided at the bushing 50 may be appropriately determined in consideration of an assembly process or the like of the vehicle seat 10.

Further, although an example in which the bushing 50 is broken (destroyed) and the notch 36C that is formed at the support wire 36 is directly anchored at the edge of the insertion hole 32A when a force with which the lumbar support 34 is pressed toward the rear side exceeds a predetermined threshold value has been explained in the present exemplary embodiment, the present disclosure is not limited thereto. For example, by increasing a strength of the bushing 50, a configuration can be provided in which the bushing 50 does not break during a rear-end collision of the vehicle. Further, a configuration can also be provided in which the notch 36C that is formed at the support wire 36 is directly anchored at the edge of the insertion hole 32A, without providing the bushing 50.

Although exemplary embodiments of the present disclosure have been explained above, the present disclosure is not limited to that which has been described above, and it is obvious that various modifications other than those described above can also be made to implement the present disclosure, within a range that does not depart from the spirit thereof.

What is claimed is:

1. A vehicle seat comprising:
a seatback that supports a back of a seated occupant from a seat rear side;
a back frame that configures a framework of the seatback and that includes an insertion portion;
a lumbar support that is arranged at a position facing a lumbar region of the seated occupant in a seat front-rear direction within the seatback; and
a wire that extends from the lumbar support toward an insertion portion side and that is anchored at the insertion portion in a state of being inserted into the insertion portion, a notch that is directly or indirectly anchored at an edge of the insertion portion when the lumbar support is pressed toward the seat rear side being formed at the wire.

2. The vehicle seat according to claim 1, wherein:
a bushing is attached to the edge of the insertion portion, and
when a force with which the lumbar support is pressed toward the seat rear side exceeds a predetermined load, the bushing is broken, and the notch is directly anchored at the edge of the insertion portion.

3. The vehicle seat according to claim 1, wherein a bushing that includes a portion formed in a shape that gradually narrows on progression toward a direction in which the wire is inserted into the insertion portion is attached to the edge of the insertion portion.
